(19) United States
(12) Patent Application Publication
(10) Pub. No.: US 2004/0020745 A1
(43) Pub. Date: Feb. 5, 2004

(54) System and method for replacing a paper currency validator in a vending machine

(76) Inventor: Wade D. Greim, Perkasie, PA (US)

Correspondence Address: Eric A. LaMorte, LaMorte & Associates, P.C., P.O. Box 434, Yardley, PA, 19067-8434, US

(21) Appl. No.: 10/207,703

(22) Filed: Jul. 30, 2002

(51) Int. Cl. G07F 7/04; G07D 7/00

(52) U.S. Cl. 194/206

(57) ABSTRACT

A system and method that enables a vending machine with one type of paper currency validator to be updated with a paper currency validator from a different manufacturer. This is done using an installation kit consisting of a replacement faceplate, an adaptor bracket and a wiring harness. To utilize the system, the original paper currency validator is removed. The faceplate that led to the old paper currency validator is also removed. The new replacement faceplate is installed in place of the old faceplate. The adaptor bracket is mounted to the vending machine using the old mounts that held the old paper currency validator in place. The new paper currency validator is mounted to the adaptor bracket. The adaptor bracket orients the new paper currency validator so that it is aligned with the new faceplate. The wiring harness is used to electrically interconnect the new paper currency validator to the electronics of the vending machine.

### BACKGROUND OF THE INVENTION

1. Field of the Invention

In general, the present invention relates to vending machines and the mechanisms used in vending machines to accept and validate paper currency. More particularly, the present invention relates to systems and methods for installing paper currency validation assemblies that can be retroactively added to vending machines that were not originally designed to receive such assemblies.

2. Prior Art Statement

The prior art is replete with different types of vending machines. Vending machines are automated machines that distribute a product or provide a service when the proper sum of money is deposited into the machine. For instance, a cigarette vending machine will distribute a pack of cigarettes when the proper sum of money is inserted into the machine. A jukebox will play a selected song once the required money is inserted into the jukebox.

Traditionally, vending machines come with coin validation units that accept and count any coined money that is inserted into the vending machine. As inflation has occurred, more and more vending machines are now manufactured with paper currency validators that accept and validate the value of paper currency. Many different companies throughout the world make vending machines. Similarly, the paper currency validators used within those vending machines are also manufactured by many different companies. Over the years, the companies that manufactured good paper currency validators thrived and the companies that manufactured poor paper currency validators failed. During the course of this evolution, one company currently dominates the paper currency validator market in the United States. That company is the Mars Electronic International of West Chester, Penn.

In the vending machine industry, a majority of vending machines with paper currency validation units use Mars® validators. Many vending companies now will only purchase vending machines with Mars® validators. In this way, the vending companies need only stock one type of replacement validator, should any of the paper currency validators in their machines break.

A problem occurring in the industry is that many older vending machines contain odd-brand paper currency validators. Many times the space available in the vending machine that holds the odd-brand paper currency validator is custom configured for that odd-brand paper currency validator. As a consequence, the odd-brand paper currency validators cannot be replaced with a more mainstream Mars® validator. This requires the owners of the vending machine to waste large amounts of money in buying and repairing odd-brand, obsolete paper currency validators.

A need therefore exists for a system and method that enables a Mars® brand paper currency validator to be retroactively added to a vending machine that was not designed to receive such a unit. This need is met by the present invention as described and claimed below.

### SUMMARY OF THE INVENTION

The present invention is a system and method that enables a vending machine with one type of paper currency validator to be updated with a paper currency validator from a different manufacturer. This is done using an installation kit consisting of a replacement faceplate, an adaptor bracket and a wiring harness.

To utilize the system, the original paper validator is removed. The faceplate that led to the old paper currency validator is also removed from the front of the vending machine. The new replacement faceplate is installed in place of the old faceplate. The adaptor bracket is mounted to the vending machine using the old mounts that held the old paper currency validator in place. The adaptor bracket contains protruding bolts. The new paper currency validator is mounted to the adaptor bracket using the protruding bolts. The adaptor bracket orients the new paper money validator so that it is aligned with the new faceplate. The wiring harness is used to electrically interconnect the new paper currency validator to the electronics of the vending machine.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a partially exploded perspective view of a prior art jukebox;

FIG. 2 is an exploded perspective view of the components of an installation kit in accordance with the present invention; and

FIG. 3 is an exploded view of the installation kit of FIG. 2 shown in conjunction with a fragment of a vending machine and a Mars® paper currency validator.

### DETAILED DESCRIPTION OF THE INVENTION

Although the present invention system can be adapted to many different types of vending machines, the present invention system is especially well suited for use on NSM brand jukeboxes. As such, and by way of example, the present invention system will be described in an application where it is applied to an NSM jukebox. This embodiment is merely exemplary and is only illustrated to set forth the best mode contemplated for the invention.

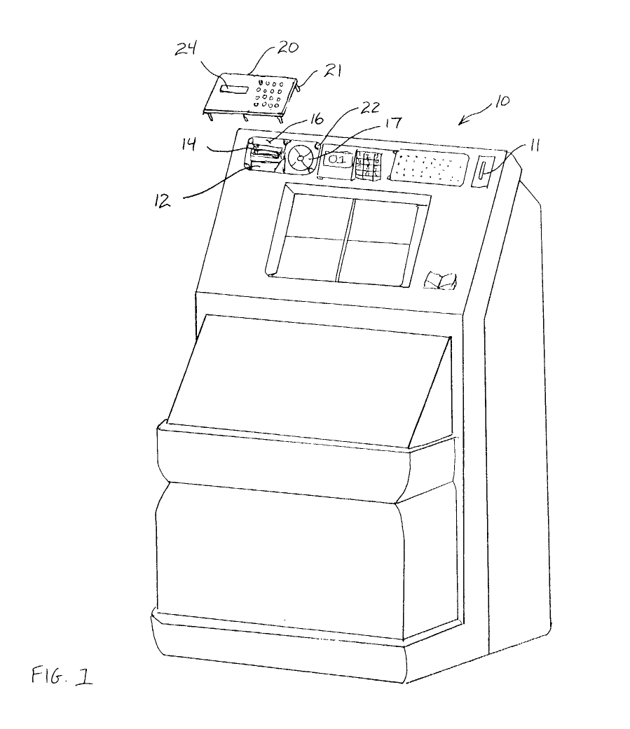

Referring to FIG. 1, a prior art NSM Performer Grand 2000 model jukebox 10 is shown. The jukebox 10 plays selections from a collection of compact discs for a fee. The fee can be paid by a customer in one of two ways. A coin slot 11 is provided near the top corner of the jukebox 10 to receive coined money. Alternatively, a paper currency validator 12 is positioned in the top corner of the jukebox 10 opposite that of the coin slot 11. The paper currency validator 12 receives and validates paper money. The coin slot 11 and the paper currency validator 12 are placed on opposite sides of the jukebox 10 for practical reasons. The coin slot 11 leads to a coin validator that counts coined money. The coined money then falls into a coin collection box. These components take up a good deal of space within the jukebox 10. The paper currency validator 12 contains the mechanism that receives and validates paper currency. The paper currency is then held in a bill storage box. These components also take up a good amount of space within the jukebox 10. In the design of the jukebox 10 shown, there is not enough room on one side of the jukebox 10 to accommodate both the coin payment related components and the paper currency payment related components. Consequently, the coin payment related components and the paper currency related components are placed on opposite sides of the jukebox 10.

In FIG. 1, it can be seen that the receiving port 14 of the paper currency validator 12 is positioned in a small opening 16, next to a speaker 17, in the face of the jukebox 10. To protect the speaker 17 and the paper currency validator 12, a faceplate 20 is mounted to the face of the jukebox 10 over the receiving port 14 of the paper currency validator 12 and the speaker 17. The faceplate 20 contains six bolts 21 that extend from the rear of the faceplate 20. The bolts 21 pass through holes 22 in the face of the jukebox 10 and are engaged with nuts from inside the jukebox 10.

If a technician wanted to replace the odd-brand paper currency validator 12 of the NSM jukebox 10 with a Mars brand validator, it cannot be readily done without time consuming and labor intensive modifications to the structure and wiring of the jukebox 10. The mounts within the jukebox 10 that support the odd-brand paper currency validator 12 differ from those required by the Mars validator. Furthermore, the access window 24 in the faceplate 20 of the NSM jukebox 10 is not of the position or size required by the Mars validator. Lastly, the electrical connections that lead to the off-brand paper currency validator 12 are not terminated with connectors that connect to the electrical ports of a Mars validator.

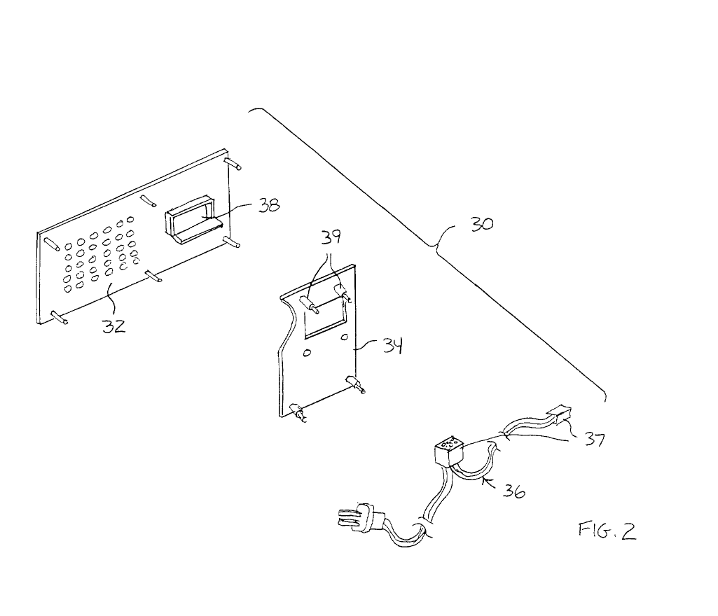

Referring to FIG. 2, an exemplary embodiment of an installation kit 30 is shown in accordance with the present invention. The installation kit 30 has three primary parts, which are a faceplate 32, an adaptor bracket 34 and a wiring harness 36. The faceplate 32 contains an access port 38 that is positioned and sized to the requirements of a Mars validator. The adaptor bracket 34 contains mounting bolts 39 that are sized and positioned to the requirements of a Mars validator. Lastly, the wiring harness 36 contains terminations 37 that are shaped to be received by the electrical connector ports of a Mars validator and the vending machine.

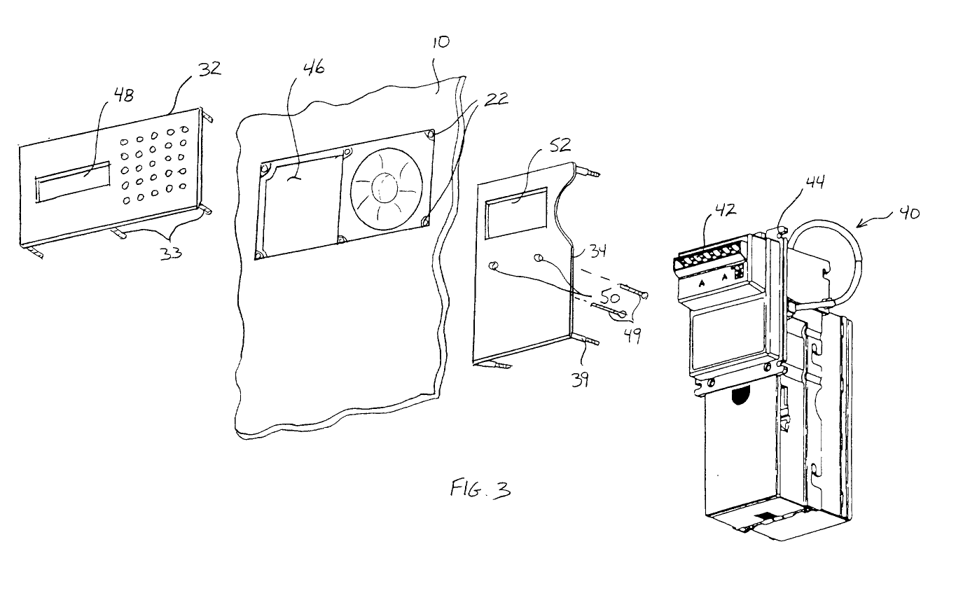

Referring now to FIG. 3, a model of a Mars validator 40 is shown for the first time. As can be seen the Mars validator 40 has a receiving port 42 that receives paper currency. A mounting plate 44 is manufactured into the structure of the Mars validator 40. The mounting plate 44 has four mounting points that are used to bolt the Mars validator 40 in place.

To install the Mars validator 40 into the NSM jukebox 10 of FIG. 1, the installation kit of FIG. 2 is used. The first step in the assembly process is the removal of the faceplate 20 (FIG. 1) that is original equipment to the jukebox 10. The odd-brand paper currency validator 12 that is original equipment to the jukebox 10 is also removed.

Referring to FIG. 4, it will now be understood that with the original faceplate and the odd-brand paper currency validator removed, an opening 46 is created in the face of the jukebox 10. To cover this opening 46, the new replacement faceplate 32 is installed. The replacement faceplate 32 has six bolts 33 extending from it that passes through the six mounting holes 22 in the face of the jukebox 10. Using the same nuts that held, the original faceplate in place, the replacement faceplate 32 is mounted into position. The replacement faceplate 32 defines an access window 48 that is sized and shaped to correspond to the requirements of the Mars validator 40. Accordingly, any paper currency fed through the access window 48 of the faceplate 32 will be in the proper position to be received by the Mars validator 40.

When the original odd-brand paper currency validator is removed from the jukebox, two mounting screws 49 are removed from the inside of the jukebox 10, just below the opening 46. Two screw holes 50 are present in the adaptor bracket 34. The screw holes 50 align with the points where mounting screws 49 engage the jukebox 10. The mounting screws 49 are then used to mount the adaptor bracket 34 to the interior of the jukebox 10.

The adaptor bracket 34 defines a window 52. When the adaptor bracket 34 is mounted to the interior of the jukebox 10, the window 52 on the adaptor bracket 34 aligns with the access window 48 on the faceplate 32. Four mounting bolts 39 extend inwardly from the adaptor bracket 34. The four mounting bolts 39 are oriented to engage the plate 44 on the Mars validator 40. Once engaged with the plate 44 on the Mars validator 40, the mounting bolts 39 retain the Mars validator 40 in a rigid position. At this position, the receiving port 42 of the Mars validator 40 aligns with the window 52 in the adaptor plate 34 and the access opening 48 in the faceplate 32. Accordingly, if a person where to place paper currency into the access opening 48 on the faceplate 32, the money would pass through the window 52 in the adaptor bracket 34 and into the receiving port 42 of the Mars validator 40.

Once the Mars validator 40 is mounted in place, the wiring harness 36 is attached to the wiring of the jukebox 10. The wiring harness 36 has a two-connector Molex connector 53 that connects to a wafer board within the jukebox 10. This lead is used to transmit money credit information to the main systems controller of the jukebox 10. The wiring harness 36 also has an A/C plug 55 that connects to a power receptacle within the jukebox 10.

As will be understood, the present invention enables a vending machine with one type of paper currency validator to be updated with a paper currency validator from a different manufacturer. This is done using an installation kit consisting of a replacement faceplate, an adaptor bracket and a wiring harness. The replacement faceplate presents a money access port that is properly positioned for the new paper currency validator. The adaptor bracket enables the new paper currency validator to attach to the mountings of the old paper currency validator. Lastly, the wiring harness enables the new paper currency validator to be wired to the electronics of the vending machine.

In the shown embodiments, a jukebox is illustrated. Such an application of the present invention is merely exemplary and it should be understood that the present invention can be adapted for use with many types of vending machines that utilize paper currency validators. In each application, a faceplate, an adaptor bracket and a wiring harness are provided. The faceplate provides a new, properly aligned money access port. The adaptor bracket enables a new paper money validator to mount to the mounting points of the validator being replaced. Lastly, the wiring harness enables the new paper currency validator to be part of the electronics of the vending machine.

It will be understood that the present invention installation system and method that are described and illustrated are merely exemplary and a person skilled in the art can make many variations to the shown embodiment. For example, vending machines come in many shapes and sizes. The shape of the replacement faceplate, adaptor bracket and wiring harness can be altered to the requirements of the vending machine and the paper currency validator being used. All such alternate embodiments and modifications are intended to be included within the scope of the present invention as defined below in the claims.

What is claimed is:

1. In a vending machine having a first paper currency validator and mounts for mounting said first paper currency validator within said vending machine behind an access faceplate, a system for replacing said first paper currency validator with a second paper currency validator, said system comprising:
a replacement faceplate for replacing said access faceplate; and
an adaptor bracket configured to mount to said mounts for said first paper currency validator, wherein said adaptor bracket supports mounts for said second paper currency validator.

2. The system according to claim 1, further including a wiring harness for wiring the second paper currency validator to the vending machine.

3. The system according to claim 1, wherein said replacement faceplate defines an access opening through which paper currency can pass.

4. The system according to claim 1, wherein said adaptor bracket contains screw holes that enable said adaptor bracket to be mechanically fastened to said mounts within the vending machine.

5. The system according to claim 4, wherein said adaptor bracket contains bolts that extend from the adaptor bracket, wherein said bolts are oriented to be received and engaged by the second paper currency validator.

6. The system according to claim 1, wherein said vending machine is a jukebox.

7. A method of replacing a first paper currency validator in a vending machine with a second paper currency validator, said method comprising the steps of:
removing the first paper currency validator from within a vending machine;
removing an original access faceplate from said vending machine through which paper money was inserted;
providing a replacement faceplate;
providing an adaptor bracket;
mounting said replacement faceplate to said vending machine in place of said original access faceplate;
mounting said adaptor bracket within said vending machine;
mounting said second paper currency validator to said adaptor bracket within said vending machine, wherein said adaptor bracket properly orients said second paper currency validator with said replacement faceplate.

8. The method according to claim 7, wherein said step of removing said first paper currency validator from said vending machine includes detaching said first paper currency validator from mount points within said vending machine.

9. The method according to claim 8, wherein said step of mounting said adaptor bracket includes mounting said bracket to at least some of said mount points of said first paper currency validator.

10. The method according to claim 7, further including the steps of providing a wiring harness and interconnecting said wiring harness between said vending machine and said second paper currency validator.

11. The method according to claim 7, wherein said vending machine is a jukebox.

12. The method according to claim 7, wherein said second paper currency validator is a paper currency validator manufactured by Mars Electronic International.

13. An installation kit for retroactively adding a paper currency validator to a vending machine, comprising:
a faceplate for mounting on said vending machine, said faceplate defining a money access port through which paper currency can be placed;
an adaptor bracket for mounting within said vending machine, said adaptor bracket defining an opening that aligns with said money access port of said faceplate and providing a structure onto which the paper currency validator can be attached and
a wiring harness for electrically connecting the paper currency validator to the vending machine.

14. The kit according to claim 13, wherein said adaptor bracket has mounting bolts extending therefrom that are engaged by the paper currency validator.
